(19) United States
(12) Patent Application Publication
(10) Pub. No.: US 2025/0389378 A1
(43) Pub. Date: Dec. 25, 2025

(54) WALL MOUNTING SYSTEM

(71) Applicants: Mark A. Lawer, Corona, CA (US); Pat Callahan, Corona, CA (US)

(72) Inventors: Mark A. Lawer, Corona, CA (US); Pat Callahan, Corona, CA (US)

(21) Appl. No.: 19/249,239

(22) Filed: Jun. 25, 2025

Related U.S. Application Data
(60) Provisional application No. 63/663,878, filed on Jun. 25, 2024.

(51) Int. Cl. F16M 13/02; F16M 11/04

(52) U.S. Cl. CPC F16M 13/02; F16M 11/046

(57) ABSTRACT

A wall mounting system may include a screen mounting system. A wall mounting system may include a display coupled to the screen mounting system. A wall mounting system may include a first vertical side column and a second vertical side column, wherein the first vertical side column and the second vertical side column are spaced horizontally away from the display. A wall mounting system may include a header positioned above the display and coupled to the first vertical side column and the second vertical side column, wherein the header includes an acoustic material to absorb a sound. A wall mounting system may include a filler panel positioned below the display and coupled to the first vertical side column and the second vertical side column.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. The present application claims priority to U.S. Provisional Patent Application No. 63/663,878 filed Jun. 25, 2024, titled WALL MOUNTING SYSTEM, the entirety of which is incorporated herein by reference.

### BACKGROUND

### Field

The present disclosure is directed to a mounting system for use in a classroom to comply with the Americans with Disabilities Act (ADA) standards for screen enclosures, wall mounted digital displays, and digital signs or structures.

### Description of the Related Art

Displays (e.g., televisions) in school classrooms or other public spaces can be difficult to integrate in a cohesive way. Currently, televisions must comply with the Americans with Disabilities Act (ADA) standards to ensure accessibility for many people, including those with disabilities. This means that simply mounting a tv on a wall would create a violation of the ADA. If these public displays are incorrectly mounted or fail to comply with ADA standards, the display may be hazardous to users who may not be aware of a protruding display or cords laying on the floor or a ground surface. For this reason, many televisions used are mounted on a moveable stand. Moveable stands are visually distracting, take up much space, and can cause problems with people running into the stand. Properly mounting a TV that complies with ADA standards can be costly, often requiring restructuring a wall to recess the TV, which also makes the TV immovable.

### SUMMARY

Accordingly, there is a need for wall mounting systems which comply with ADA standards and which can be retrofit onto exiting walls or in existing classrooms without costly construction. Therefore, and as described herein, a wall mounting system is designed order to attach a display (e.g., interactive display) to a screen mounting system which complies with ADA requirements for protruding displays. The wall system described herein is also aesthetically pleasing, creating a warm and inviting environment that can enhance student's learning experience.

In some examples, a wall mounting system for reducing noise in a classroom setting can include a screen mounting system. The wall mounting system can include a display coupled to the screen mounting system. The wall mounting system can include a first vertical side column and a second vertical side column. The first vertical side column and the second vertical side column are spaced horizontally away from the display. The wall mounting system can include a header positioned above the display and coupled to the first vertical side column and the second vertical side column. The header can include an acoustic material to absorb a sound. The filler panel can be positioned below the display and coupled to the first vertical side column and the second vertical side column. To adjust a height of the display, the screen mounting system moves the display upwards and downwards along a wall between the header and the filler panel.

In some examples, the screen mounting system is attached to a sheet coupled to the wall. In some examples, the first vertical side column and the second vertical side column extend along an entire height of the wall mounting system. In some examples, the header is made of tackable material. In some examples, the filler panel is a kick panel.

In some examples, a thickness of the filler panel is between 0.6 inches and 1.1 inches. In some examples, an opening is formed between the filler panel and the wall. In some examples, the display does not protrude more than 4 inches away from the wall. In some examples, a space is formed between the first vertical side column, the second vertical side column, the header, and the filler panel, wherein the space dampens the sound transmitted from the display.

In some examples, a wall mounting system for use in reducing noise in a classroom setting can include an acoustic box coupled to a wall. The acoustic box can have a plurality of sides forming a perimeter of the acoustic box. The plurality of sides can extend away from the wall. The plurality of sides can form a space. The acoustic box can be formed from acoustic materials to dampen a sound within the space; a screen mount positioned within the plurality of sides of the acoustic box. The screen mount can have a front side and a rear side, the rear side coupled to the wall. The front side translates vertically within the acoustic box relative to the rear side. The screen mount is manually powered. A display can be coupled to the front side of the screen mount and can generate the sound. A header can be positioned above the acoustic box. The header can include acoustic materials to dampen the sound. To move the display to an upward position, the front side of the screen mount moves a vertical distance towards an upper side of the plurality of sides of the acoustic box.

In some examples, a panel is positioned below the acoustic box. In some examples, a header is positioned above the acoustic box, wherein the header and the acoustic box together reduce a total amount of noise transmitted within a room.

In some examples, a hideaway store wall is external to the acoustic box and along the wall. In some examples, the screen mount restricts movement of the display to within the space in order to reduce an amount of the sound that can be transmitted through the wall. In some examples, one or more slat portions are external to the acoustic box and along the wall. In some examples, one or more whiteboards are positioned external to the acoustic box and along the wall. In some examples, a gap is formed between two sides of the plurality of sides, wherein the gap allows a user to contact the display.

In some examples, a method of operating a wall mounting system for use in reducing noise in a classroom setting includes positioning a rear side of a wall mount on a wall. The wall mount has a front side opposite to the rear side. The front side is coupled to a display. The method includes surrounding the wall mount and the display with an acoustic box. The acoustic box can have a plurality of sides protruding away from the wall. The method includes forming a space between the plurality of sides of the acoustic box and the display. The method includes dampening a sound transmitted from the display within the space. The method includes translating the display upwards and downwards within the space.

In some examples, the method includes restricting movement of the display to within the space in order to reduce an amount of the sound that can be transmitted through the wall. In some examples, the method includes damping the sound with a header positioned above the acoustic box.

### BRIEF DESCRIPTION OF THE DRAWINGS

FIG. 1 is a front view of a wall mounting system.

FIG. 2A is a side cross-sectional view of the wall mounting system of FIG. 1.

FIG. 2B is a side cross-sectional view of the wall mounting system of FIG. 1 including a sheet attached to a wall.

FIG. 3A is a top cross-sectional view of the wall mounting system of FIG. 1.

FIG. 3B is a top cross-sectional view of the wall mounting system of FIG. 1 including a sheet attached to a wall.

FIG. 4A is a front view of another example of a wall mounting system.

FIG. 4B is a partial front view of the wall mounting system of FIG. 4A.

FIG. 4C is a top perspective view of the wall mounting system as shown in FIG. 4B.

FIG. 4D is a top perspective view of a screen mount for the wall mounting system of FIG. 4A.

### DETAILED DESCRIPTION

Disclosed below is a wall mounting system for use in a classroom or school setting. When mounting a display (e.g., a TV or a smartboard) to a wall using a mounting system, such as, for example, a mounting system marketed under the name BalanceBox™ sold by Regout Balance Systems B.V. of The Netherlands, the combined depth of the wall mounting system and the display typically to exceed the Americans with Disabilities (ADA) standard for mounting devices to walls. The current ADA standard requires that the combined depth (e.g., distance the mount and the display extend from the wall or fixed surface be less than 4 inches. However, installing an adjustable mounting system with a display in a classroom conventionally is not compliant with ADA standards since the combined depth of the mount and the display will exceed 4 inches. Further, and according to ADA Standards for Accessible Design (2010), objects projecting from walls with their leading edges between 27 inches and 80 inches above the floor must not protrude more than 4 inches into walks, corridors, passageways, or aisles (ADA 307.2 Protruding Objects). This requirement ensures the safety of individuals who are blind or have low vision so that they can detect obstacles or protruding surfaces with their canes. Advantageously, installing a wall mounting system, as disclosed herein, designed to ensure that the total combined depth of the wall mounting system and the display does not extend more than 4 inches from the wall will allow classrooms or other spaces to be compliant with the ADA standards. Additionally, using a wall mounting system as disclosed herein will allow the display (e.g., smartboard) to be mounted to a wall instead of being placed on a cart, which can be obtrusive and can occupy a significant amount of space in a classroom. Advantageously, the wall mounting system disclosed herein assists individuals with vision impairments (e.g. blindness, low vision, etc.) so that they do not unintentionally contact the display and wall mounting system, causing injury.

The wall mounting system, as disclosed herein can allow safe and easy installation of displays in classrooms or other public systems. In order to install a display (e.g., interactive display) which meets ADA requirements, schools or public areas may typically have to carve out a space (e.g., create a hole in wall) in order to recess the display or screen mount such that the total combined depth of the mount and the display from the wall is less than 4 inches. The wall mount system as disclosed herein does not require the wall to have a cutaway section and instead can be retrofitted on to a current wall in a classroom or public space. The wall mount system disclosed herein includes a header installation and a filler panel. The arrangement of the header installation and the filler panel allow the display (e.g., interactive display) to be flush (e.g., even) or essentially flush with a wall and therefore does not protrude more than 4 inches into a walkway or passageway, particularly when combined with a larger wall system including dry erase boards, chalk boards and other wall boards. The wall mounting system can prevent a user (e.g., school, public space) from having to carry out significant construction in the wall or room in order to have an accessible display meeting ADA requirements.

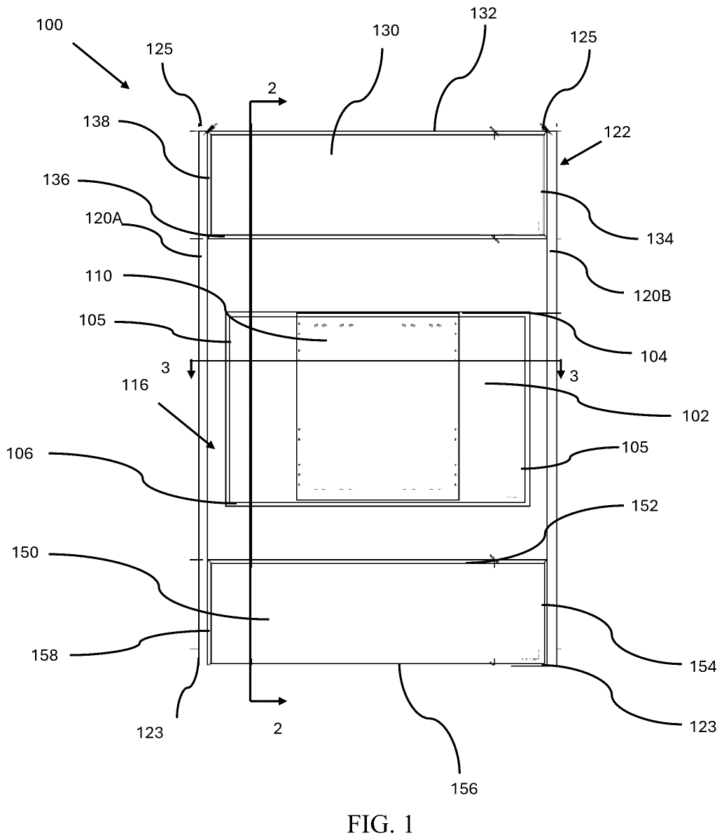

FIG. 1 shows a wall mounting system 100. The wall mounting system 100 can be used, for example, with a screen mount 110. A screen mount 110 (such as a BalanceBox™) can be a manually operated height adjustable screen mount. A display 102 (e.g., a SMART Board, a television, an LED display) can be attached or fixed to the wall mounting system 100. Advantageously, the screen mount 110 can move upwards and downwards along a wall 122 (e.g., from an upper location and to a lower location) so that a user (e.g., a teacher, child, or student) can reach the screen or display 102 (e.g., interactive screen) so that the user can interact with the display 102. The screen mount 110 can move vertically (e.g., upwards/downwards, movement from the floor to the ceiling of a classroom) between a range of approximately 15-28 inches. The movement of the screen mount 110 can allow the display 102 to move to a desired vertical position along the wall 122 (e.g., to a lower position for a child to reach). In some implementations, the screen mount 110 can move vertically along the wall 122 at least 15 inches, at least 15.75 inches, at least 16 inches, at least 17 inches, at least 18 inches, at least 19 inches, at least 20 inches, at least 21 inches, a least 22 inches, at least 23 inches, at least 24 inches, at least 25 inches, at least 26 inches, at least 27 inches, and/or at least 28 inches. The screen mount 110 can be suitable for very large screens or displays. The maximum load capacity of the screen mount 110 can be approximately 200-400 lbs. Furthermore, the screen mount 110 can be easily movable, and can move upwards and downwards along the total vertical travel distance only with a light touch of a finger of a user, where little to no power (e.g., electric power) is necessary to move the display 102 coupled to (e.g., fixedly attached, operatively connected to) the screen mount 110. The screen mount 110 can be designed to last for multiple years and can translate upwards and downwards for numerous cycles (e.g., approximately 60,000 cycles).

The wall mounting system 100 can include a header 130 and a filler panel 150. The header 130 may be positioned above the display 102 and the screen mount 110. The filler panel 150 may be positioned below the display 102 and the screen mount 110. The display 102 can translate upwards and downwards within a space 116. The space 116 can be between the header 130 and the filler panel 150. The space 116 can also be bounded by two vertical side columns 120A, 120B. Advantageously, the screen mount 110 can be positioned within the space 116 such that the display 102 can translate (e.g., upwards and downwards) such that the 102 does not contact the header 130 and the filler panel 150. The space 116 can have a height 118 of approximately 6 feet. Additionally, the space 116 can have a height 118 of approximately 5.8 feet, 5.9 feet, 6.1 feet, 6.2 feet, 6.3 feet, 6.4 feet, 6.5 feet, 6.6 feet, 6.7 feet, 6.8 feet, 6.9 feet, 7.0 feet, 7.1 feet, and 7.2 feet.

The wall mounting system 100 can include one or more (e.g. two) vertical side columns 120A, 120B. The two vertical side columns 120A, 120B can be aluminum tubes or aluminum plates. The two vertical side columns 120A, 120B can be spaced away from the display 102 along a horizontal direction (e.g., the sides 105 of the display 102 do not contact the two vertical side columns 120A, 120B). The vertical side columns can extend from the top of the wall mounting system 100 and to the bottom (e.g., floor) of the wall mounting system 100. The two vertical side columns 120A, 120B can be coupled to (e.g., fixedly attached, adhered to) the header 130 and the filler panel 150. The two vertical side columns 120A, 120B can be horizontally spaced apart from each other by approximately 6 feet and 8.125 inches. Additionally, the two vertical side columns 120A, 120B can be horizontally spaced apart by at least 6 feet, 6.1 feet, 6.2 feet, 6.3 feet, 6.4 feet, 6.5, feet 6.6 feet, 6.7, feet, 6.8 feet, 6.9 feet, and 7 feet. The two vertical side columns 120A, 120B may have a total height (e.g., total vertical height) of approximately 10 feet. The two vertical side columns 120A, 120B may also be spaced approximately 6 inches away from the sides 105 of the display 102. The total height of the two vertical side columns 120A, 120B may be identical to or correspond with the total height 166 of the wall mounting system 100.

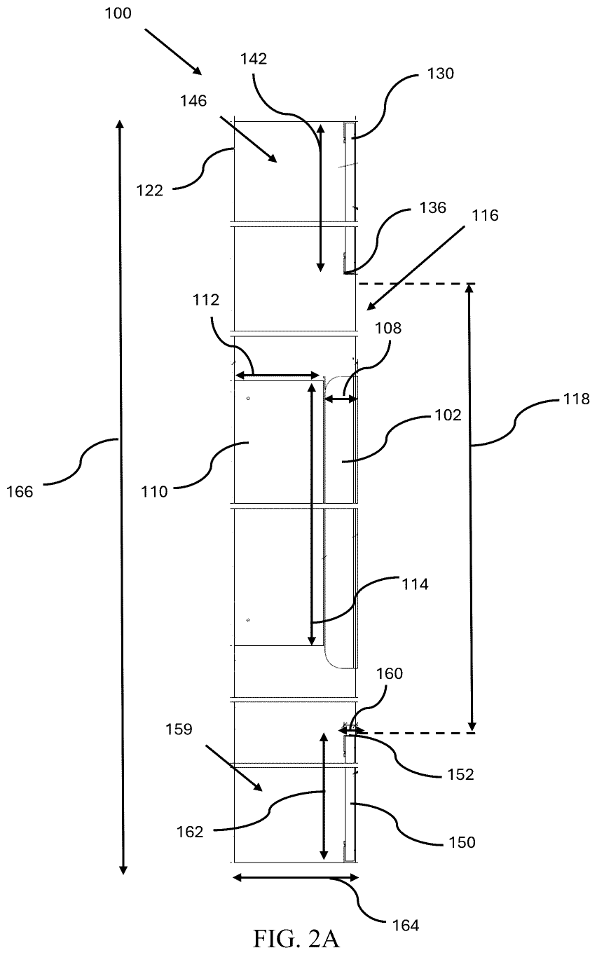

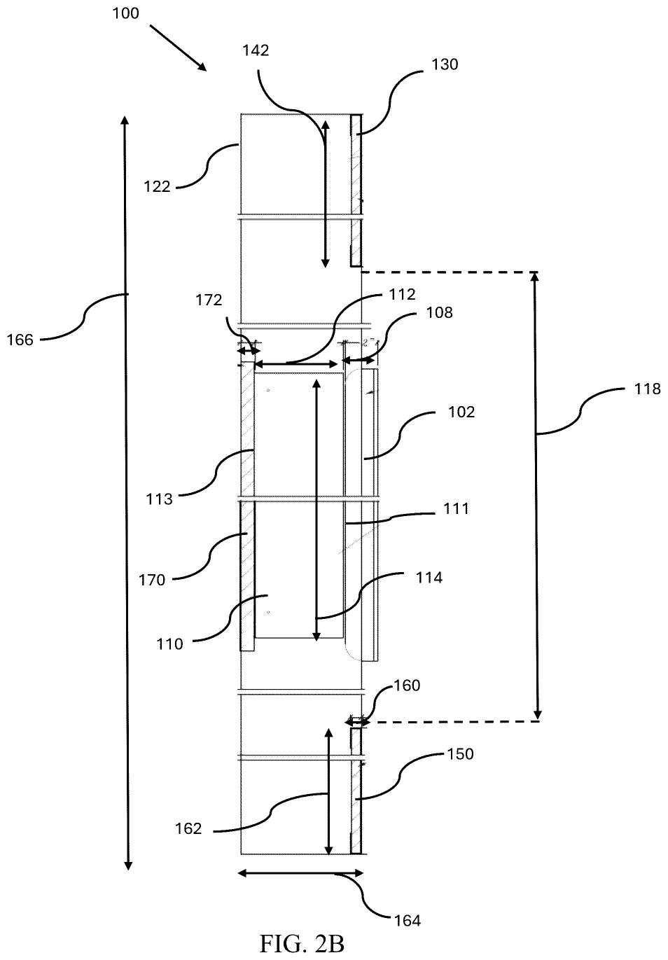

The header 130 can have an upper side 132, a right side 134, a bottom side 136, and a left side 138. The header 130 can be made of or can include porcelain enamel steel. A vertical side column 120A can be coupled to the left side 138 of the header 130. The other vertical side column 120B can be coupled to the right side 134 of the header 130. The topmost portion 125 of two vertical side columns 120A, 120B can be adjacent to or approximately flush (e.g., even) with the upper side 132 of the header 130 and the topmost portion wall mounting system 100. An opening 146 can be formed between the header 130, the two vertical side columns 120A, 120B, and the wall 122 (see FIGS. 2A-2B). The header 130 can have a height 142 (see FIGS. 2A-2B) of approximately two feet. Additionally, the header 130 can have a height 142 (see FIGS. 2A-2B) of at least 1.8 feet, at least 1.9 feet, at least 2.1 feet, at least 2.2 feet, at least 2.3 feet, at least 2.4 feet, and at least 2.5 feet. Advantageously, the header 130 can be sized such that the display 102 (e.g., top 104 of the display 102) can translate upwards without contacting bottom side 136 of the header 130.

The filler panel 150 can have a top portion 152, a right portion 154, a bottom portion 156, and a left portion 158. A vertical side column 120A can be coupled to the left portion 158 of the filler panel 150. The other vertical side column 120B can be coupled to the right portion 154 of the filler panel 150. The bottommost portion 123 of the two vertical side columns 120A, 120B can be adjacent to or approximately flush (e.g., even) with the bottom portion 156 of the filler panel 150, the floor, and/or the bottommost portion of the wall mounting system 100. An opening 159 can be formed between the filler panel 150, the two vertical side columns 120A, 120B, and the wall 122 (see FIGS. 2A-2B). The filler panel 150 can have height 162 (see. FIGS. 2A-2B) of approximately two feet. Additionally, the filler panel 150 can have height 162 (see. FIGS. 2A-2B) of approximately 1.8 feet, 1.9 feet, 2.1 feet, 2.2 feet, 2.3 feet, 2.4 feet, and/or 2.5 feet. Advantageously, the filler panel 150 can be sized such that the display 102 (e.g., the bottom 106 of the display 102) can translate downwards without contacting the top portion 152 of the filler panel 150. The filler panel 150 can be sized such that the display 102 can translated downwards such that the top portion 152 of the filler panel 150 remains at least 6 inches below the bottom 106 of the display 102.

FIGS. 2A-2B show a side cross-sectional view of the wall mounting system 100. The screen mount 110 can be attached (e.g., fixedly attached) to a wall 122 directly via fasteners or an adhesive. The wall 122 advantageously does not need to have a cutout section or a carve out section which matches the profile of the display 102 and/or screen mount 110 due to the wall mounting system 100. The wall mounting system 100 can be assembled on to a current wall (e.g., retrofit onto wall 122) or structure without high construction costs. The screen mount 110 can also be attached to a sheet 170 positioned on the wall 122. The sheet 170 can be a plywood sheet. The sheet 170 can be directly attached to the wall 122 with one or more fasteners (e.g., screws, bolts, adhesive). The sheet 170 allows the screen mount 110 and the display 102 of the wall mounting system 100 to be easily installed onto the wall 122 without added complexity or tools (e.g., drywall saws, hole saws). The sheet 170 can be fixedly connected to a rear 113 of the screen mount 110 in order to support the screen mount 110 and the display 102 on the wall 122. The sheet 170 can have a thickness 172 of at least 0.75 inches. The sheet 170 can have a thickness 172 of at least 0.6 inches, at least 0.7 inches, at least 0.8 inches, at least 0.9 inches, at least 1.0 inches, or at least 1.1 inches.

The screen mount 110 can have a depth or thickness 112 (e.g., between the rear 113 and front 111 of the display 102) of approximately 5.5 inches. The screen mount 110 can also have a depth or thickness 112 of at least 5.0 inches, at least 5.1 inches, at least 5.2 inches, at least 5.3 inches, at least 5.4 inches, at least 5.5 inches, at least 5.6 inches, at least 5.7 inches, at least 5.8 inches, at least 5.9 inches, or at least 6.0 inches. The screen mount 110 can have a height 114 of approximately 3.5 feet. The screen mount 110 can also have a height 114 of at least 3.0 feet, at least 3.1 feet, at least 3.2 inches, at least 3.3 feet, at least 3.4 feet, at least 3.6 feet, at least 3.7 feet, at least 3.8 feet, at least 3.9 feet, or at least 4 feet. The display 102 can have a depth or thickness 108 of between approximately 1.5 inches and 4 inches.

The header 130 can include acoustic materials to absorb sound (e.g., sounds from the display 102). Additionally, the acoustic materials of the header 130 can provide tackability which can allow a user to add items or displays easily above the display 102. The acoustic materials can include acoustic panels, foam, mineral wool, wood fiber, synthetic fibers, etc. The acoustic materials may also have a sound absorption coefficient of 0.10 when tested in accordance with ISO 354. The sound absorption coefficient of the materials used in the wall mounting system 100 may be between 0.1 to 0.5.

The filler panel 150 can be a kick panel. The filler panel 150 include or be made of porcelain enamel steel. The filler panel 150 can be designed such that it has a leading edge or front portion which is within the sweep of a cane (e.g., a distance up to 27 inches from the ground or floor) since the filler panel 150 can extend upwards from the floor to a height of approximately 2 feet. The thickness 160 of the filler panel 150 can be approximately 0.75 inches. The thickness 160 of the filler panel 150 can be at least 0.6 inches, at least 0.7 inches, at least 0.8 inches, at least 0.9 inches, at least 1.0 inches, or at least 1.1 inches.

The total depth 164 of the wall mounting system 100 can be approximately 7.5 inches. The total depth 164 of the wall mounting system 100 can be approximately 6.5 feet, 6.6 feet, 6.7 feet, 6.8 feet, 6.9 feet, 7.0 feet, 7.1 feet, 7.2 feet, 7.3 feet, 7.4 feet, 7.5 feet, 7.6 feet, 7.7 feet, 7.8 feet, 7.9 feet, 8.0 feet, 8.1 feet, 8.2 feet. The total height 166 of the wall mounting system 100 can be approximately 10 feet. The total height of the wall mounting system can be approximately 9.6 feet, 9.7 feet, 9.8 feet, 9.9 feet, 10.1 feet, 10.2 feet, 10.3 feet, 10.4 feet, 10.5 feet.

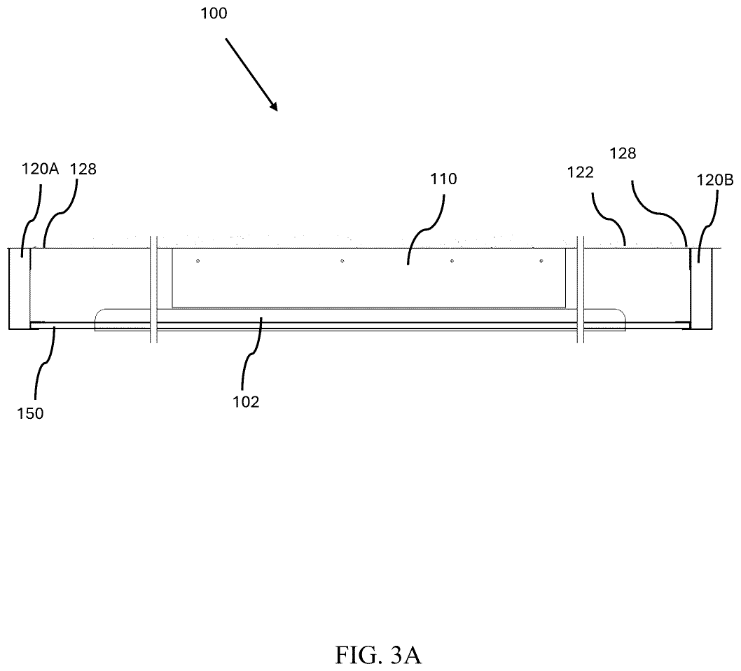

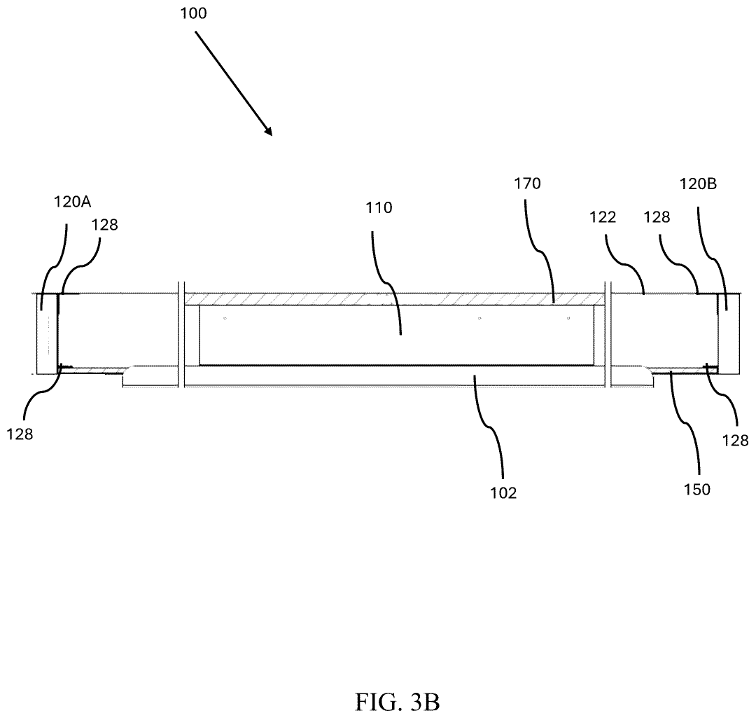

FIGS. 3A-3B show a top cross-sectional view of the wall mounting system 100. The two vertical side columns 120A, 120B are coupled to the wall 122 and the filler panel 150 via one or more angle brackets 128. The one or more angle brackets 128 can be four angle brackets 128, where two of the one or more angle brackets 128 can be fixed to the two vertical side columns 120A, 120B and the wall and another two of the one or mor angle brackets 128 are couped to the filler panel 150 and the two vertical side columns 120A, 120B.

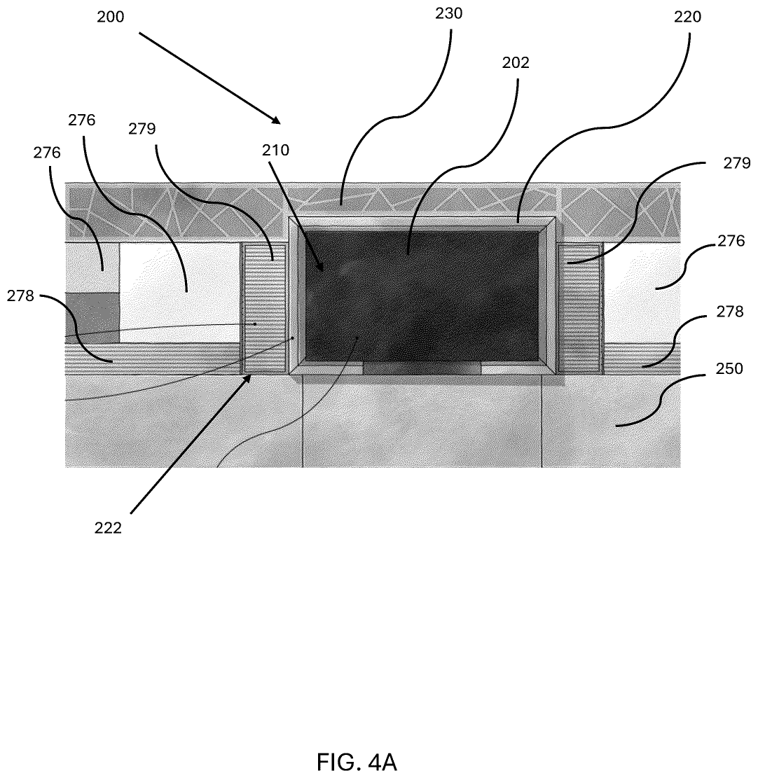

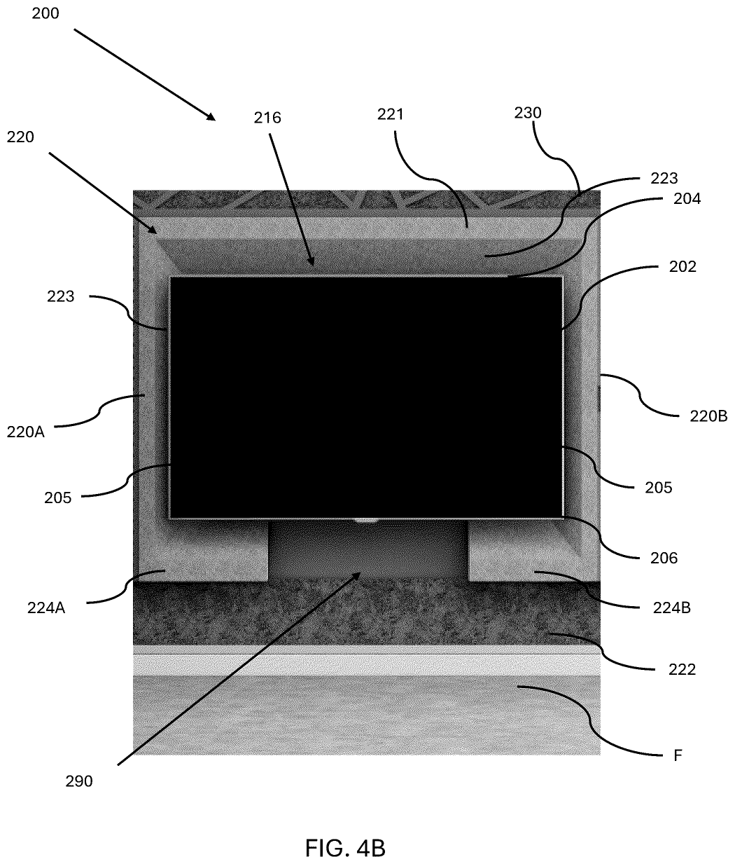

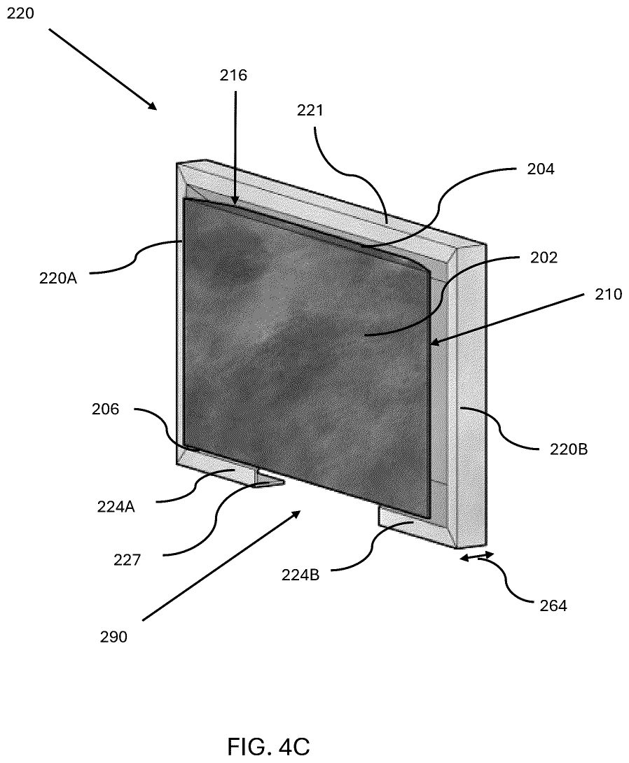

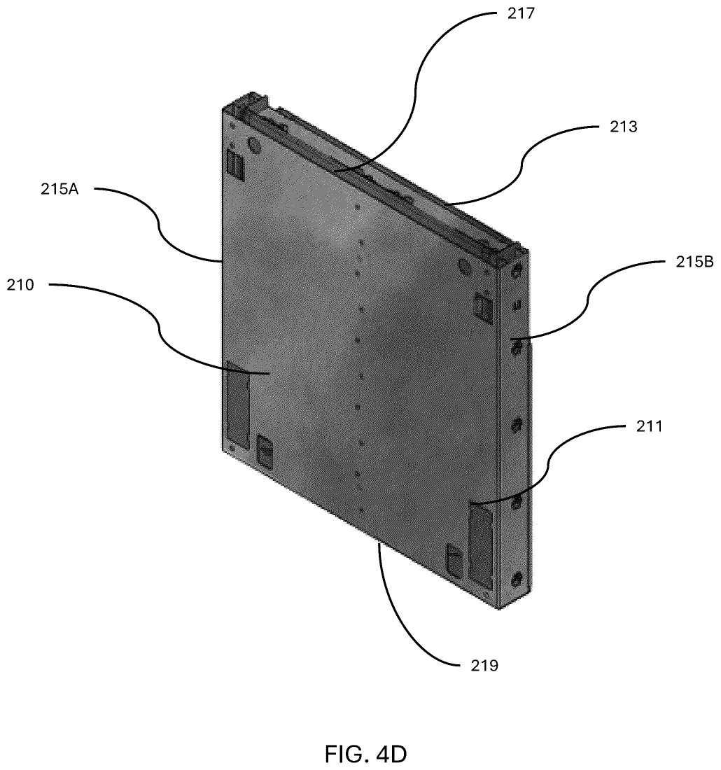

FIGS. 4A-4D show another example wall mounting system 200. The wall mounting system 200 can be used, for example, with a screen mount 210. Some of the features of the wall mounting system 200 and screen mount 210 are similar to the wall mounting system 100 and screen mount 110 previously described in connection with FIGS. 1-3B. Therefore, the reference numerals used to designate the various components of the wall mounting system 200 and screen mount 210 may be identical to those used for identifying the corresponding components of the wall mounting system 100 and screen mount 110 in FIGS. 1-3B, except that the numerical identifiers now start with a “2”. The structure and description for the various features of the wall mounting system 100 and the screen mount 110 in FIGS. 1-3B and how they are operated and controlled are understood to also apply to the corresponding features of the wall mounting system 200 the screen mount 210.

The screen mount 210 (such as a BalanceBox™) can be a manually operated height adjustable screen mount. A display 202 can be attached to the screen mount 210. The screen mount 210 may be positioned behind the screen portion of the display 202 and affixed to a wall 222. The screen mount 210 can move upwards and downwards along the wall 222.

The screen mount 210 and display 202 may be positioned within an acoustic box 220. The acoustic box 220 can surround the top 204, the bottom 206, and the sides 205 of the display 202. The acoustic box 220 can dampen the sound transmitted from or produced by the display 202. Advantageously, the acoustic box 220 provides a way to prevent sound from travelling into adjoining rooms (e.g., other classrooms in a school). The acoustic box 220 may also dampen echoes and can reduce background noise produced by the display 202. The acoustic box 220 may be made from sound absorbing materials. The sound absorbing materials can include acoustic panels, foam, mineral wool, wood fiber, synthetic fibers, etc. The acoustic materials may also have a sound absorption coefficient of 0.10 when tested in accordance with ISO 354. The sound absorption coefficient of the materials used in the wall mounting system 200 (and the acoustic box 220) may be between 0.1 to 0.5.

The acoustic box 220 can include two vertical side columns 220A, 220B, an upper portion 221, and two lower portions 224A, 224B. Each of the two vertical side columns 220A, 220B, the upper portion 221, and the two lower portions 224A, 224B can surround the display 202 and the screen mount 210. The acoustic box 220 may dampen the sounds formed within a space 216 of the screen mount 210 formed by the two vertical side columns 220A, 220B, the upper portion 221, and the two lower portions 224A, 224B. A gap 290 can be formed between the first lower portion 224A and the second lower portion 224B. The gap 290 can allow a user to easily grab the bottom 206 of the display 202 in order to translate the display 202 upwards and downwards along the wall 222. Additionally, the gap 290 can allow a user to operate the controls (e.g., power button, channel, display settings) of the display 202. The screen mount 210 allows the display 202 to translate vertically within the space 216 formed between the acoustic box 220 and the display 202. For example, the top 204 of the display 202 can translate upwards towards the upper portion 221 of the acoustic box 220. The top 204 of the display 202 may not translate past the upper portion 221 of the acoustic box 220 in order to enable sound dampening within the space 216 at any desired vertical location of the display 202. The display 202 can be restricted from movement outside of the space 216. For example, the bottom 206 of the display 202 can translate downwards towards the two lower portions 224A, 224B of the acoustic box 220. The bottom 206 of the display 202 may not translate past (e.g., outside) the two lower portions 224A, 224B. The sound produced or transmitted by the display 202 may stay within the space 216. The acoustic box 220 may have a total depth 264 (e.g., a distance the acoustic box 220 protrudes from the wall 222). The two lower portions 224A, 224B may protrude way from the wall 222 from a support portion 227 of the acoustic box 220.

The acoustic box 220 can have one or more (e.g., five) sloping walls 223 extending from the perimeter of the acoustic box 220 (formed by the two vertical side columns 220A, 220B, the upper portion 221, and the two lower portions 224A, 224B) and towards the wall 222. The sloping walls 223 can absorb sound transmitted by the display 202 (preventing sound from travelling to an adjoining classroom) while also allowing sound from the display 202 to be heard within a classroom. The sloping walls 223 may allow the acoustic box 220 to provide a high level of noise insulation and while also allowing clear and understandable communication (e.g., sound from the display 202).

The two lower portions 224A, 224B of the acoustic box 220 may be elevated from the floor F of a room. The space between the floor F and the two lower portions 224A, 224B of the acoustic box 220 may be occupied or filled by a panel 250. The panel 250 can be sized such that the display 202 (e.g., the bottom 206 of the display 202) can translate downwards without contacting the panel 250. The panel 250 can also be tackable. The panel 250 can have a surface that allows a variety of different colors to be placed over (e.g., attached) the wall 222 in order to create a more conducive learning environment (e.g., due to the appealing colors for students).

The wall mounting system 200 can include a header 230. The header 230 can include acoustic materials to absorb sound (e.g., sounds generated by the display 202). The header 230 may also be tackable in order to allow a user to place images or decals on the wall mounting system 200 (e.g., for display, information, or artwork). The header 230, in combination with the acoustic box 220, may reduce the total amount of sound transmitted from within a classroom (e.g., via the display 202, student voices, background noise, etc.) and to other areas of a school, which can cause distraction. The acoustic materials of the header 230 can include acoustic panels, foam, mineral wool, wood fiber, synthetic fibers, etc. The acoustic materials may also have a sound absorption coefficient of 0.10 when tested in accordance with ISO 354. The sound absorption coefficient of the materials used in the header 230 may be between 0.1 to 0.5.

The wall mounting system 200 can also include a hideaway store wall 279. The hideaway store wall 279 may allow a user to place items needed for instruction near the display 202 for easy access. The hideaway store wall 279 may allow a user to store items (e.g., notebooks, classroom materials, pens, etc.) in an easy to access location and hidden, such that it reduces classroom distraction. The hideaway store wall 279 can rotate from an open position and to a closed position to allow the user to access the items within the wall mounting system 200. The hideaway store wall 279 can be positioned outside of the acoustic box 220. The wall mounting system 200 can also include one or more whiteboards or chalkboards 276. The wall mounting system 200 may also include one or more slat portions 278. The one or more slat portions 278 may be used to place items (e.g., pens, pencils, writing utensils) close to an instruction area (e.g., the one or more whiteboards or chalkboards 276). The one or more slat portions 278 may be positioned below the one or more whiteboards or chalkboards 276. The chalkboards 276 and one or more slat portions 278 can be external to the acoustic box 220.

The screen mount 210 can have a rear 213 and a front 211. The rear 213 of the screen mount 210 can be opposite the front 211. The front 211 of the screen mount 210 can be coupled to the display 202. The rear 213 can be attached to the wall 222. In some examples, the rear 213 of the screen mount 210 can be attached to a wall of the acoustic box 220. The screen mount 210 may have an upper portion 217, a lower portion 219, and two sides 215A, 215B. The front 211 of the screen mount 210 may translate upwards and downwards relative to the rear 213. The distance the front 211 of the screen mount 210 can translate vertically relative to the rear 213 of the screen mount 210 can be based on the size of the acoustic box 220 (e.g., the distance between the upper portion 221 and the two lower portions 224A, 224B of the acoustic box 220).

The wall mounting systems 100, 200 can form one part of a larger wall system that creates a flush and organized classroom system. The larger wall system can include white boards, slat boards, chalk boards, storage areas, push pin boards. The entire wall system can be added to an existing wall without further modifications and can create a flush system of TVs, boards, and storage areas. The entire system thus creates a decluttered classroom that complies with ADA standards and does not require expensive retrofits of existing walls.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

What is claimed is:

1. A wall mounting system for reducing noise in a classroom setting, comprising:
a screen mounting system;
a display coupled to the screen mounting system;
a first vertical side column and a second vertical side column, wherein the first vertical side column and the second vertical side column are spaced horizontally away from the display;
a header positioned above the display and coupled to the first vertical side column and the second vertical side column, wherein the header includes an acoustic material to absorb a sound; and
a filler panel positioned below the display and coupled to the first vertical side column and the second vertical side column;
wherein, to adjust a height of the display, the screen mounting system moves the display upwards and downwards along a wall between the header and the filler panel.

2. The wall mounting system of claim 1, wherein the screen mounting system is attached to a sheet coupled to the wall.

3. The wall mounting system of claim 1, wherein the first vertical side column and the second vertical side column extend along an entire height of the wall mounting system.

4. The wall mounting system of claim 1, wherein the header is made of tackable material.

5. The wall mounting system of claim 1, wherein the filler panel is a kick panel.

6. The wall mounting system of claim 1, wherein a thickness of the filler panel is between 0.6 inches and 1.1 inches.

7. The wall mounting system of claim 1, wherein an opening is formed between the filler panel and the wall.

8. The wall mounting system of claim 1, wherein the display does not protrude more than 4 inches away from the wall.

9. The wall mounting system of claim 1, wherein a space is formed between the first vertical side column, the second vertical side column, the header, and the filler panel, wherein the space dampens the sound transmitted from the display.

10. A wall mounting system for use in reducing noise in a classroom setting, comprising:
an acoustic box coupled to a wall, the acoustic box having a plurality of sides forming a perimeter of the acoustic box, the plurality of sides extending away from the wall, the plurality of sides forming a space, wherein the acoustic box is formed from acoustic materials to dampen a sound within the space;
a screen mount positioned within the plurality of sides of the acoustic box, the screen mount having a front side and a rear side, the rear side coupled to the wall, wherein the front side translates vertically within the acoustic box relative to the rear side, wherein the screen mount is manually powered;
a display coupled to the front side of the screen mount generating the sound; and
a header positioned above the acoustic box, wherein the header includes acoustic materials to dampen the sound;
wherein, to move the display to an upward position, the front side of the screen mount moves a vertical distance towards an upper side of the plurality of sides of the acoustic box.

11. The wall mounting system of claim 10, further comprising a panel positioned below the acoustic box.

12. The wall mounting system of claim 10, further comprising a header positioned above the acoustic box, wherein the header and the acoustic box together reduce a total amount of noise transmitted within a room.

13. The wall mounting system of claim 10, further comprising a hideaway store wall external to the acoustic box and along the wall.

14. The wall mounting system of claim 10, wherein the screen mount restricts movement of the display to within the space in order to reduce an amount of the sound that can be transmitted through the wall.

15. The wall mounting system of claim 10, wherein one or more slat portions are external to the acoustic box and along the wall.

16. The wall mounting system of claim 10, wherein one or more whiteboards are positioned external to the acoustic box and along the wall.

17. The wall mounting system of claim 10, wherein a gap is formed between two sides of the plurality of sides, wherein the gap allows a user to contact the display.

18. A method of operating a wall mounting system for use in reducing noise in a classroom setting, the method comprising:
positioning a rear side of a wall mount on a wall, wherein the wall mount has a front side opposite to the rear side, the front side coupled to a display;
surrounding the wall mount and the display with an acoustic box, the acoustic box having a plurality of sides protruding away from the wall;
forming a space between the plurality of sides of the acoustic box and the display;
dampening a sound transmitted from the display within the space; and
translating the display upwards and downwards within the space.

19. The method of claim 18, further comprising restricting movement of the display to within the space in order to reduce an amount of the sound that can be transmitted through the wall.

20. The method of claim 18, further comprising damping the sound with a header positioned above the acoustic box.
